(19) United States
(12) Patent Application Publication
(10) Pub. No.: US 2024/0413354 A1
(43) Pub. Date: Dec. 12, 2024

(54) CARBON SUPPORTS, CATALYSTS, MEMBRANE ELECTRODE ASSEMBLIES, POLYMER ELECTROLYTE MEMBRANE FUEL CELLS, AND RELATED METHODS

(71) Applicant: The Trustees of Indiana University, Bloomington, IN (US)

(72) Inventors: Jian Xie, Zionsville, IN (US); Qing Gong, Nanchang (CN)

(21) Appl. No.: 18/676,717

(22) Filed: May 29, 2024

Related U.S. Application Data
(60) Provisional application No. 63/471,600, filed on Jun. 7, 2023.

(51) Int. Cl. H01M 4/92; H01M 4/88; H01M 8/1004

(52) U.S. Cl. CPC H01M 4/926; H01M 4/8817; H01M 4/8882; H01M 8/1004; H01M 2250/20

(57) ABSTRACT

A method of forming a catalyst on a catalyst support, combination of catalysts and carbon supports produced thereby, and applications therefor, including catalyst layers, electrodes, membrane electrode assemblies (MEAs), polymer electrolyte membrane fuel cells, and vehicles. Such a method includes guiding ions of a precursor of a catalyst to land uniformly on an NH₂-modified surface of a catalyst support, and depositing fine monodisperse nanoparticles on the NH₂-modified surface. Ultrafine noble metal-transitional metal intermetallic nanoparticles (e.g., PtM) can be directly synthesized on catalyst supports (e.g., carbon supports). Noble metal nanoparticles (e.g., Pt) are monodispersed on a catalyst support through electrostatic attraction established between a precursor of the intermetallic nanoparticles and protonated ammonium ions (NH₃⁺) immobilized over surfaces of the catalyst support. The monodisperse noble metal nanoparticles are then used as seeds to form the intermetallic nanoparticles.

### CROSS-REFERENCE TO RELATED APPLICATIONS

This application claims the benefit of provisional U.S. Patent Application No. 63/471,600 filed Jun. 7, 2023, the contents of which are incorporated herein by reference.

### BACKGROUND OF THE INVENTION

The present invention generally relates to materials, devices and systems that utilize catalysts, particularly but not limited to electrocatalysts used in fuel cells, electrolyzers, and other energy conversion and storage devices. The invention particularly relates to carbon supports, catalysts, membrane electrode assemblies (MEAs), and related methods, and to polymer electrolyte membrane (PEM) fuel cells that utilize such carbon supports, catalysts, and membrane electrode assemblies, including but not limited to fuel cells for use in vehicles and other systems (e.g., submarines, locomotives, airplanes, stationary power generations, uninterrupted power supplies, etc.).

Polymer electrolyte membrane (PEM) fuel cells are a promising energy conversion device for automotive and stationary applications because of their zero-carbon emission and high efficiency. As schematically represented in FIG. 5, PEM fuel cells utilizing catalysts 10 supported on a catalyst support 12 are commercially used to catalyze the sluggish oxygen reduction reaction (ORR) on the cathode side of membrane electrode assemblies (MEAs). The MEAs often utilize platinum-containing nanoparticles as the catalyst 10 supported on surfaces of a carbon support 12 (Pt/C). Unfortunately, the high cost, low ORR activity, and unsatisfactory durability of Pt/C catalysts have hindered large-scale adoption of PEM fuel cells.

An effective strategy to reduce Pt usage while enhancing activity is to form Pt-based alloys with transition metals (M), such as iron (Fe), cobalt (Co), nickel (Ni), zinc (Zn), and/or other transition metals. In particular, Pt—Co and Pt—Ni alloys are two of the most active Pt-based catalysts. The activity enhancement can be ascribed to the favorable ligand and strain effects on the surface Pt, which are known to weaken the adsorption of oxygenated intermediates in the related rate-determining steps. Because Pt and M atoms in Pt—M alloys are randomly distributed in a face-centered cubic (fcc) lattice, the M atoms can be rapidly leached out when subjected to the corrosive environment of PEM fuel cells, resulting in degradation of catalytic kinetics and poisoning of electrodes and membranes.

More recently, ordered Pt-based intermetallics have been considered promising candidates to achieve both excellent activity and high durability in fuel cell applications. Face-centered tetragonal (fct) L1₀-PtM and cubic L1₂-Pt₃M are two typical ordered Pt-based intermetallics in which Pt and M atoms occupy specific lattice sites and have fixed atomic ratios. Compared with the L1₂-Pt₃M structure, the L1₀-PtM is beneficial in further reducing the Pt content but has been less studied. The L1₀-PtM intermetallic structure endows a strong electronic interaction between M (3d) and Pt (5d) atomic orbitals along the crystallographic c direction, which could inhibit M atoms against oxidation and thus leaching.

Generally, L1₀-PtM structures are formed by high-temperature (e.g., 600° C. and higher) heat treatment of disordered PtM alloy counterparts since atomic ordering is a thermally driven process. Unfortunately, under traditional processing conditions, high temperatures would inevitably lead to migration and agglomeration of PtM nanoparticles, forming undesirably large and non-uniform particles, resulting in low electrochemical surface area (ECSA) and thus unsatisfactory catalytic performance. The preferred size of Pt-based nanoparticles for ORR catalysis is currently considered to be about 2 to about 3 nm with a narrow size distribution. To overcome particle agglomeration, a typical strategy is to individually prepare PtM nanoparticles using organic surfactants, then deposit them on carbon supports followed by a high-temperature heat treatment. Unsatisfactory particle sizes (5 nm and larger), low Pt loading (10 wt. % and less), and weak catalyst-carbon interaction are common drawbacks for this synthesis strategy. Low Pt loadings on carbon supports may increase mass transport resistance in MEAs because of thicker catalyst layers, while a weak catalyst-carbon interaction is detrimental to the catalyst durability. Another synthesis strategy is to utilize protective coatings such as SiO₂, MgO, and carbonized polymers to hinder the migration and aggregation of PtM nanoparticles during a high-temperature heat treatment. Although this method can reduce the particle size to about 3 to 6 nm, it is difficult to completely remove the protective coatings, leaving surface residues that can block the active sites and thus increase mass transport resistance. Therefore, it is of paramount importance to develop a simple method to directly deposit ultrafine (which as used herein refers to particle sizes of less than 3 nm, also sometimes referred to as “sub-3 nm”) and uniform L1₀-PtM intermetallic nanoparticles with a reasonable Pt loading (for example, greater than 20 wt. %) on carbon supports.

Numerous Pt-based catalysts have shown encouraging intrinsic activity in liquid half-cell testing using the rotating disk electrode (RDE) technique. However, translating these outstanding intrinsic activities into fuel cell performance is a considerable challenge. The RDE technique maximizes the catalyst utilization and minimizes the mass transport resistance by simplifying the reaction zone from a three-phase interface to a two-phase interface, to which the dissolved oxygen and protons in liquid electrolytes are supplied through the electrode rotation. To enhance the active site density for liquid half-cell testing, highly active Pt-based nanoparticles were almost exclusively supported on high surface-area carbon, in which large amounts of nanoparticles are embedded inside micropores (which as used herein refers to pores having a pore size of less than 2 nm) of carbon support. However, when such a catalyst is incorporated into a catalyst layer of MEAs, the embedded active sites are poorly accessible to reactants of oxygen and protons, leading to ineffective utilization of the inside active sites and additional mass transport resistance. This results in unsatisfactory MEA performance at practical working voltages. For instance, in H₂/air fuel cells using a cathode loading below 0.125 mgₚₜ·cm⁻², the maximum rated power density (at 0.67 V) reported in published literature is around 0.82 W·cm⁻², which is well below the U.S. Department of Energy (DOE) target of 1.0 W·cm⁻² for transportation applications. Pore engineering of carbon supports is an effective approach to improve catalyst utilization and mass transport in the catalyst layers. Pt nanoparticles mainly located in opened mesopores (which as used herein refers to pores having a pore size of 2 to 50 nm) of carbon supports, appearing primarily on the carbon external surface, are known to be easily accessible to reactants, which are desired for high-performance MEAs.

In view of the above, it would be desirable if processes were available that were capable of uniformly distributing ultrafine PtM intermetallic (for example, L1₀-PtM) nanoparticles on carbon supports with reasonable Pt loading and high accessibility for applications including but not limited to fuel cell applications.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods capable of forming a catalyst on a catalyst support, the combination catalyst and carbon supports produced thereby, a catalyst layer, an electrode, membrane electrode assemblies (MEAs), polymer electrolyte membrane fuel cells, and vehicles.

According to a nonlimiting aspect of the invention, a method of forming a catalyst on a catalyst support includes guiding ions of a precursor of the catalyst to land uniformly on an NH₂-modified surface of the catalyst support, and depositing fine monodisperse nanoparticles on the NH₂-modified surface having the ions of the precursor thereon.

According to other nonlimiting aspects of the invention, combination catalyst and catalyst supports are provided that are formed by the method described above, catalyst layers are provided that include such a combined catalyst and catalyst support, electrodes are provided that include such a catalyst layer, membrane electrode assemblies are provided that include such an electrode, and polymer electrolyte membrane fuel cells are provided that include such a membrane electrode assembly.

Technical aspects of methods and materials having features as described above preferably include the capability of directly synthesizing highly accessible ultrafine noble metal intermetallic nanoparticles (e.g., PtM) on catalyst supports (e.g., carbon supports). The synthesis of such intermetallic nanoparticles may utilize monodisperse Pt nanoparticles as seeds supported on a NH₂-modified carbon support. The nanoparticles are monodispersed on a catalyst support through a strong electrostatic attraction established between a precursor of the intermetallic nanoparticles and protonated ammonium ions (NH₃⁺) immobilized over surfaces of the catalyst support. The NH₂ modification of a carbon support has been determined to tailor the pore structure of the carbon support, enabling the deposition of noble metal-containing intermetallic nanoparticles in opened mesopores at the carbon support surface, which are highly accessible to reactants of oxygen and protons in MEAs.

Other aspects and advantages will be appreciated from the following detailed description.

### BRIEF DESCRIPTION OF THE DRAWINGS

FIG. 1A schematically illustrates a method of forming PtCo/KB—NH₂ nanoparticles according to certain aspects of the invention.

FIGS. 1B and 1C contain TEM images and corresponding particle size distributions (insets) of Pt/KB—NH₂ (FIG. 1B) and PtCo/KB—NH₂ (FIG. 1B) formed in accordance with the method of FIG. 1A.

FIGS. 2A through 2E depict various aspects relating to distribution information and structure characterizations of PtCo/KB and PtCo/KB—NH₂ nanoparticles formed in accordance with the method of FIG. 1A. FIGS. 2A and 2B are STEM images of PtCo/KB, and FIGS. 2C and 2D are STEM images of PtCo/KB—NH₂. FIGS. 2A and 2C are secondary electron (SE) images, and FIGS. 2B and 2D are high-angle annular dark field (HAADF) images. FIG. 2E contains an atomic-resolution STEM image with corresponding FFT pattern (inset),

FIGS. 3A through 3F depict various aspects relating to electrocatalytic performances of commercial Pt/C, PtCo/KB, and PtCo/KB—NH₂ catalysts tested using RDE technique. FIG. 3A is a graph plotting CV curves. FIG. 3B is a graph plotting ORR polarization curves tested in 0.1 mol·L⁻¹ HClO₄ solutions. FIG. 3C is a graph plotting mass activities and specific activities obtained at 0.9 V_{iR}-free. FIG. 3D is a graph plotting CV curves. FIG. 3E is a graph plotting ORR polarization curves tested at the beginning of life (BOL) and after 30,000 potential cycles between 0.60 and 0.95 V in 0.1 mol·L⁻¹ HClO₄ solutions. FIG. 3F is a graph plotting variations of mass activity after 30,000 potential cycles.

FIGS. 4A through 4D depict various aspects relating to characterization analyses and DFT calculations for conventional commercial Pt/C and new PtCo/KB—NH₂ catalysts of the present invention. FIG. 4A is a graph plotting XPS Pt 4f spectra for the commercial Pt/C and the PtCo/KB—NH₂. FIG. 4B is a graph plotting wavelet transform of the Pt L3-edge EXAFS spectra for the commercial Pt/C, Pt foil, and the PtCo/KB—NH₂. FIG. 4C is a graph plotting calculated E_{OH*} on L1₀-PtCo@Pt_{3L} (111) with 3.42% compressive strain, Pt (111) with 3.42% compressive strain, and unstrained Pt (111). The top insets are slab models and the right insets are semispherical models for a 2.6 nm L1₀-PtCo@Pt_{3L} nanoparticle, in which blue and yellow spheres represent Pt and Co atoms, respectively. FIG. 4D is a graph plotting partial density of states (PDOS) of Pt 5d states on unstrained Pt (111) and L1₀-PtCo@Pt_{3L} (111) with 3.42% compressive strain.

FIG. 5 schematically represents catalyst nanoparticles supported on a catalyst support to catalyze an oxygen reduction reaction (ORR) on the cathode side of a membrane electrode assembly (MEA).

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also describes certain investigations relating to the embodiment(s) depicted in the drawings, and identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Nonlimiting aspects and embodiments of the invention are described below in reference to experimental investigations leading up to the invention. The investigations involved the preparation of ultrafine (sub-3 nm) L1₀-PtCo intermetallic nanoparticles supported on NH₂-modified electroconductive carbon black, abbreviated herein as PtCo/KB—NH₂. The PtCo/KB—NH₂ exhibited excellent ORR activity and durability, originating from a favorable structure of Pt layers of about 2 to 3 atoms formed over a L1₀-PtCo core. Benefitting from the high accessibility of PtCo/KB—NH₂ nanoparticles, MEA produced therewith delivered enhanced Pt utilization and lower mass transport resistance, resulting in breakthrough fuel cell performance. While the investigations reported below were directed to PtCo/KB—NH₂ structures, it will be appreciated that the teachings of the invention may also be generally applicable to the creation of catalyst supports on which catalyst nanoparticles are supported, including other PtM intermetallics and carbon supports for various applications, including but not limited to electrolyzers and other energy conversion and storage devices. Such carbon supports may include, but are not limited to, carbon blacks with high structure and low structure, graphites, graphenes, and other carbon support materials.

The present application discloses, among other aspects, a new method of synthesizing platinum alloy catalysts (including PtCo, PtNi, PtFe, PtZn, etc.) with the ordering intermetallic structure. The methods can result in uniformly distributing accessible ultrafine PtM intermetallic nanoparticles on carbon supports. In some nonlimiting aspect, the method includes using NH₂ functionalized carbon support to synthesize Pt based intermetallic catalysts in order to achieve (1) the guided landing of Pt precursor ions to form uniformly distributed Pt seeds over the carbon surface. This guided landing helps later-formed Pt based intermetallic catalyst nanoparticles to realize uniform particle distribution. The method may also achieve (2) engineering the pore structure of the carbon support to fill the micropores so that all Pt based nanoparticles will be on the external surface of carbon support as well as in the mesopores. The method can cause the resulting ordered intermetallic Pt alloy catalyst nanoparticles to be completely accessible for oxygen, which, in turn, significantly increases the mass activity, ECSA, power density of the catalyst in both a RDE and a MEA.

In some nonlimiting aspects, methods are disclosed herein for directly synthesizing highly accessible sub-3 nm L1₀-PtM intermetallic nanoparticles on carbon supports. The synthesis of such L1₀-PtM intermetallic nanoparticles uses monodisperse Pt nanoparticles supported on NH₂-modified carbon as seeds, which is achieved through a strong electrostatic attraction established between the Pt-precursor (PtCl₆²⁻) and protonated ammonium ions (NH₃⁺) immobilized over carbon surfaces. The NH₂ modification tailors the pore structure of carbon supports, enabling the deposition of L1₀-PtM intermetallic nanoparticles mainly in the opened mesopores of carbon surfaces, which are highly accessible to reactants of oxygen and protons in MEAs. In some nonlimiting examples, sub-3 nm L1₀-PtCo nanoparticles supported on NH₂-modified ketjenblack (PtCo/KB—NH₂) prepared using this method exhibited excellent ORR activity and durability, which it is believed originated from the favorable structure of 2˜3 atomic Pt layers formed over the L1₀-PtCo core. Benefitting from the high accessibility of PtCo/KB—NH₂ nanoparticles, the MEA delivered enhanced Pt utilization and lowered mass transport resistance, resulting in breakthrough fuel cell performance.

Various materials and chemicals utilized in the investigations are generally summarized as follows. Materials used included Ketjenblack (KB) carbon black EC300J (AkzoNobel Surface Chemistry), Vulcan (VC) XC-72 (Cabot Corporation), phenylenediamine (97%, Alfa Aesar) as a source of p-benzene amino (—NH₂) groups, chloroplatinic acid hexahydrate (H₂PtCl₆·6H₂O, 38-40% Pt, Strem Chemicals) as a platinum (Pt) precursor, anhydrous cobalt chloride (CoCl₂, 97%, Thermo Scientific) as a cobalt (Co) precursor, sulfuric acid (ACS reagent grade, Sigma-Aldrich), sodium nitrite (NaNO₂, 98%, Alfa Aesar), deionized water (18.2 MΩ·cm), filtration membrane (0.025 μm, Millipore Corporation), ethylene glycol (certified grade, Fisher Chemical), n-propanol (certified ACS, Fisher Scientific), ionomer solution (NAFION D520, Ion Power), ionomer solution (720 EW, Aquivion D72-25BS), Gore membrane (15 μm, M820.15), NAFION membrane (NR211, Ion Power), 46.4 wt. % Pt/C (TEC10E50E, Tanaka Kikinzoku Kogyo), 30 wt. % Pt/C (Jiping New Energy), and gas diffusion layers (Sigracet 22BB, SGL Global).

The investigations evaluated amino (—NH₂) surface modifications (“NH₂-modified”) to carbon supports (hereinafter sometimes referred to as an NH₂-modified carbon support, or simply NH₂-modified carbon). For these nonlimiting investigations, the NH₂-modified carbon supports were prepared using a diazonium reaction method. Briefly, 100 mg KB or 300 mg VC was dispersed into 100 mL of deionized water, followed by the addition of 56 mg phenylenediamine and 30 L of concentrated sulfuric acid. After sonication for 30 minutes, 36 mL of a 1.0 mg·mL⁻¹ NaNO₂ aqueous solution were added dropwise into the suspension above. The reaction product was collected after magnetic stirring for 16 hours at 60° C. by filtering using deionized water on a 0.025 μm filtration membrane. The resulting carbon was dried in a vacuum oven at 65° C. for 12 hours and then ground in an agate mortar. The amount of phenylenediamine introduced was calculated based on the surface area of carbon supports, and an excess of phenylenediamine was used to ensure maximum surface coverage of p-benzene-NH₂ on the carbon supports.

For use in the nonlimiting investigations, Pt/KB—NH₂, PtCo/KB—NH₂, PtCo/KB, and “traditional” PtCo/KB (prepared without seed mediation and carbon modification) were synthesized as outlined below.

Pt/KB—NH₂ was synthesized by depositing Pt nanoparticles on NH₂-modified KB (KB—NH₂) by reducing a Pt-precursor in an ethylene glycol aqueous solution (60 vol. % EG/40 vol. % H₂O). Briefly, KB—NH₂ was dispersed in the ethylene glycol aqueous solution, followed by the addition of a certain amount of H₂PtCl₆·6H₂O used as the Pt precursor. The suspension was refluxed at 140° C. for 6 hours, then filtrated with deionized water and ethanol. Finally, Pt/KB—NH₂ was obtained after drying the product at 65° C. for 12 hours in a vacuum oven. For comparison, Pt/KB was also prepared using the same procedure, except that unmodified KB was used as support material. The nominal Pt loading was set at 8.0 wt. %, and the detailed loading was determined using thermogravimetric analysis (TGA).

PtCo/KB—NH₂ was synthesized by initially dispersing 100 mg of 8.0 wt. % Pt/KB—NH₂ in 50 mL of deionized water, followed by adding 0.077 mmol of H₂PtCl₆·6H₂O and 0.153 mmol of CoCl₂ used as the Co precursor. After sonication for 30 minutes, the suspension was then subjected to magnetic stirring at 60° C. until the water fully evaporated to form a thick slurry. The slurry was dried in a vacuum oven at 65° C. for 12 hours and then ground in an agate mortar. The grounded powder was heated in a tube furnace at 400° C. for 2 hours and then at 650° C. for another 6 hours under flowing forming gas (5 vol. % H₂/95 vol. % Ar). The heating rate was maintained at 8° C·min⁻¹. The product was then treated in a 0.1 mol·L⁻¹ HClO₄ solution at 60° C. for 6 hours in air, followed by a heat treatment at 400° C. for 1 hour under flowing forming gas. The Pt loading for PtCo/KB—NH₂ was determined to be 24.0 wt. % using inductively coupled plasma atomic emission spectroscopy (ICP-AES).

PtCo/KB was synthesized by initially dispersing 100 mg of 8.0 wt. % Pt/KB in 50 mL of deionized water, followed by the addition of 0.128 mmol of H₂PtCl₆·6H₂O and 0.220 mmol of CoCl₂, and then the same subsequent procedure as that described above for synthesizing PtCo/KB—NH₂. The Pt loading for PtCo/KB was determined to be 23.5 wt. % using ICP-AES.

As noted above, “traditional” PtCo/KB was prepared utilizing a traditional impregnation method without seed mediation and carbon modification. The method entailed initially dispersing 85 mg KB in 50 mL of deionized water, followed by the addition of 0.154 mmol of H₂PtCl₆·6H₂O and 0.201 mmol of CoCl₂, and then the same subsequent procedure as that described above for synthesizing PtCo/KB—NH₂. The Pt loading of PtCo/KB-traditional was determined to be 24.6 wt. % using ICP-AES.

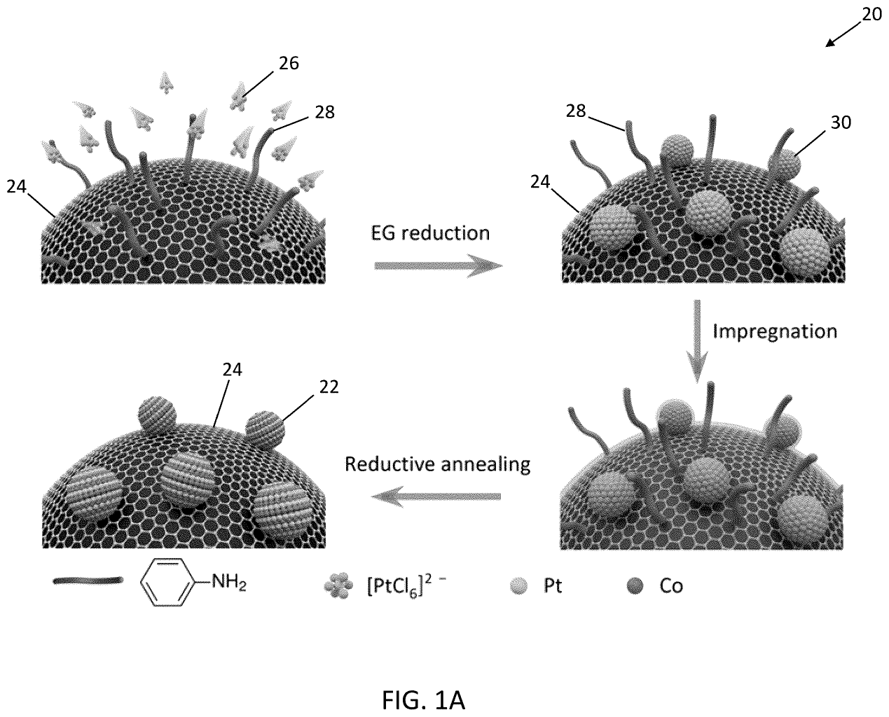

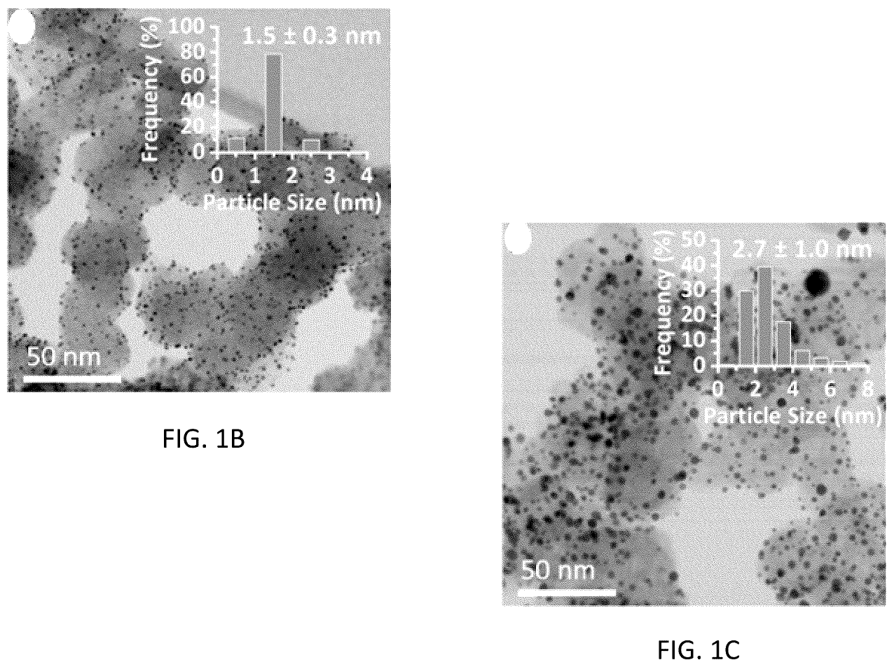

FIG. 1A illustrates a method 20 of forming a catalyst on a catalyst support. In this nonlimiting example, the method is used to form L1₀-PtCo intermetallic nanoparticles 22 supported on NH₂-modified carbon supports 24 that were utilized for investigations leading the present invention. An NH₂-modified carbon support 24 was initially synthesized utilizing the diazonium reaction method described above. An XPS N 1 s spectra demonstrated the successful covalent grafting of p-benzene amino (—NH₂) groups over the surface of a carbon black material (Ketjenblack (KB) EC300J), with a surface N content of 4.4 at. %. The-NH₂ groups significantly blocked the small pores (micropores) of the KB carbon, which led to a remarkable decrease in Brunauer-Emmett-Teller (BET) specific surface area from 769 m²·g⁻¹ of KB to 170 m²·g⁻¹ of KB—NH₂. Apparently, the KB carbon black material contained large numbers of micropores (pore sizes of less than 2 nm) with a high specific micropore volume of 0.20 cm³·g⁻¹, which decreased by 90.0% to 0.02 cm³·g⁻¹ after the modification yielding the NH₂-modified KB (KB—NH₂). However, the specific volume of mesopores (pore sizes of 2 to 50 nm) remained at a high level of 0.72 cm³·g⁻¹ for KB—NH₂, indicating a slight reduction of 8.0% relative to that of KB. Catalyst nanoparticles embedded in the micropores of carbon supports are poorly accessible to proton-conducting ionomers and oxygen gas in an MEA, whereas sufficient mesopores could ensure efficient access of protons/oxygen and facilitate the formation of desired catalyst/ionomer interfaces.

For the subsequent Pt deposition, a modified ethylene glycol (EG) method was employed. The Pt complex ions (PtCl₆²⁻) 26 of the Pt precursor (H₂PtCl₆·6H₂O) in the EG aqueous solution and protonated ammonium ions (NH₃) 28 on the KB—NH₂ surface exhibited opposite charges, resulting in a strong electrostatic attraction. Apparently, this attraction guided the Pt complex ions 26 to land uniformly on the NH₂-modified carbon surface, enabling the deposition of fine monodisperse Pt nanoparticles 30 on the KB—NH₂ (FIG. 1B). For Pt/KB—NH₂ with a Pt loading of 8.0 wt. %, the average size of Pt nanoparticles was determined to be 1.5±0.3 nm. As a comparison, the Pt nanoparticles deposited on the unmodified KB exhibited a larger average size and a wider size distribution of 1.6±0.5 nm due to the lack of electrostatic attraction guidance. The uniform deposition of Pt nanoparticles on KB—NH₂ also demonstrated the homogeneous grafting of —NH₂ groups on KB—NH₂. A strong electronic interaction between Pt nanoparticles and KB—NH₂ was revealed in the Pt/KB—NH₂, as evidenced by considerably positive shifts in binding energies of N 1 s and Pt 4f spectra relative to that of KB—NH₂ and Pt/KB, respectively. Such an electronic interaction is believed to provide an anchoring effect for Pt nanoparticles and retard particle migration and coalescence that would occur during a subsequent heat treatment (annealing) process.

To obtain L1₀-PtCo intermetallic nanoparticles supported on KB—NH₂, the Pt/KB—NH₂ was impregnated with the previously-noted Pt and Co precursors followed by heat treatment (annealing) under a forming gas atmosphere. The uniform and fine Pt nanoparticles on KB—NH₂ served as seeds to guide the impregnation (deposition) of the Pt and Co precursors and the subsequent formation/growth of PtCo alloy nanoparticles and the formation/growth of PtCo intermetallic nanoparticles following heat treatment. The formation and structure evolution of L1₀-PtCo intermetallic nanoparticles during the heat treatment were investigated using in-situ synchrotron high energy X-ray diffraction (SHEXRD), which could be divided into three stages based on the heat treatment (annealing) process. The first stage was a heating process from room temperature to 400° C., which clearly revealed the reduction of the Co and Pt precursors (respectively, CoCl₂·2H₂O and H₂PtCl₆·6H₂O), accompanied by slight alloying (the positive shifting of (111), (200), (220), and (311) peaks). The second stage was a two-hour hold at 400° C., which corresponded to further alloying as the Co atoms continuously diffused into the Pt fcc lattice. For the third stage, the heat treatment temperature was increased to 650° C., during which the characteristic peaks of the L1₀-PtCo structure gradually appeared, accompanied by further alloying. The intensity of peaks indexed to (001), (110), and (201) planes for the L1₀-PtCo structure gradually increased with heating time, which was attributed to the gradual structure transformation from a disordered PtCo alloy to an atomically ordered L1₀-PtCo intermetallic. Although the presence of —NH₂ groups may improve the uniformity of ionomer distribution within the catalyst layers, their stability has been demonstrated to be insufficient to withstand harsh fuel cell testing conditions, resulting in decreased durability. The —NH₂ groups on the carbon surface were decomposed during the high-temperature heat treatment, as evidenced by the disappearance of the XPS N 1 s peak in the PtCo/KB—NH₂ in the XPS N 1 s spectra, which may be beneficial to maintain the durability of L1₀-PtCo intermetallic nanoparticles.

To ensure the formation of the L1₀-PtCo structure, a slight excess of the Co precursor was introduced during the impregnation step. After 6 hours at the heat treatment temperature of 650° C., a post acid treatment was performed to remove excess metallic Co on the carbon surface. Based on ICP-AES analyses, the Pt loading of the resulting PtCo/KB—NH₂ was determined to be 24.0 wt. %. As shown in FIG. 1C, the PtCo intermetallic nanoparticles for PtCo/KB—NH₂ were uniformly distributed over the carbon surface with an average size of 2.7±1.0 nm. As a comparison, the PtCo intermetallic nanoparticles for PtCo/KB (Pt loading of 23.5 wt. %), prepared using a similar procedure except for NH₂-modification of the carbon, showed a larger average size and a wider size distribution of 3.0±1.5 nm. Both PtCo/KB—NH₂ and PtCo/KB exhibited more uniform and much smaller nanoparticles when compared with the PtCo/KB-traditional (6.2±2.5 nm, Pt loading of 24.6 wt. %) prepared using a traditional impregnation method without both carbon modification and seed mediation. From this, it was concluded that seed mediation enabled the effective deposition of fine intermetallic nanoparticles over the carbon surface, and the NH₂-modification further improved the uniformity of the Pt nanoparticle seeds, resulting in more uniform and fine L1₀-PtCo intermetallic nanoparticles of PtCo/KB—NH₂. In the investigations, L1₀ intermetallic PtFe/KB—NH₂ and L1₀ intermetallic PtCo/VC—NH₂ (with average particle sizes of 2.6 ±0.9 nm and 3.4±1.1 nm, respectively) were also produced using the NH₂-modification synthesis technique described above, which demonstrated that the technique can be used for different PtM intermetallics and carbon supports. For the sake of brevity, the following is limited to discussions of the structures and performance analysis of the PtCo/KB—NH₂ structures.

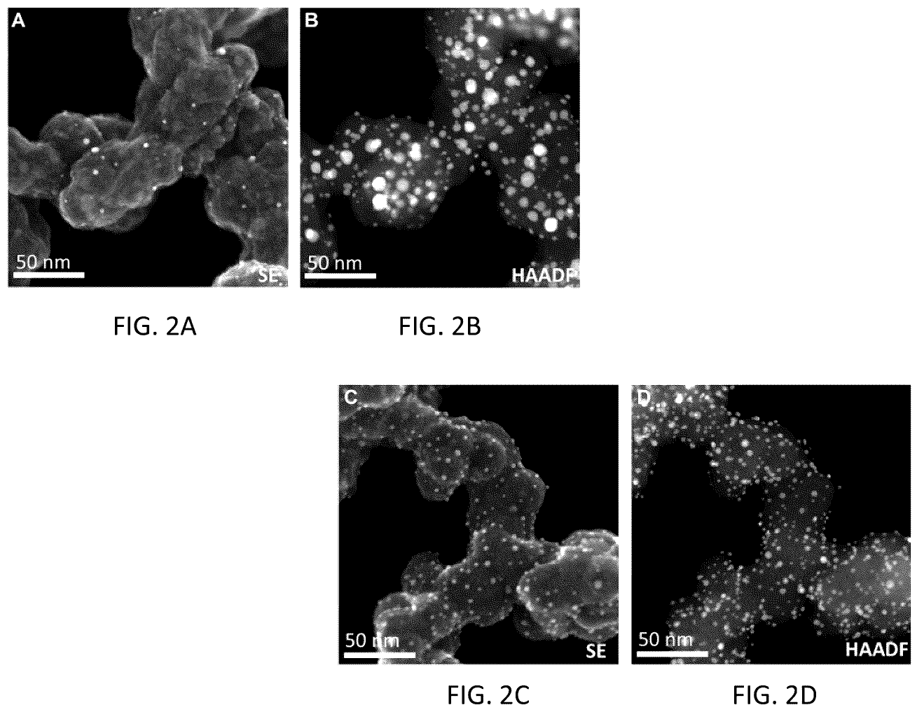

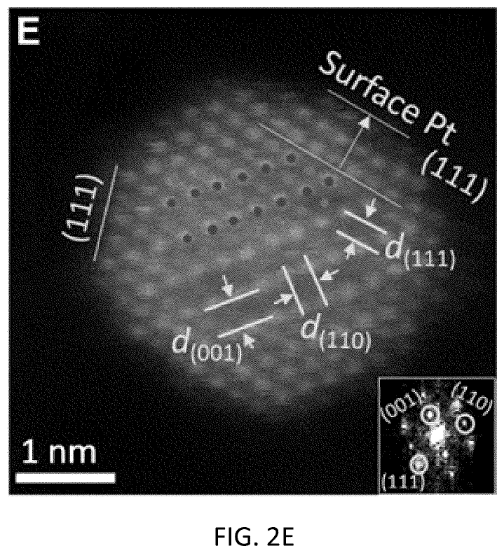

The location of Pt nanoparticles relative to the internal or external surfaces of a carbon support is known to affect the MEA performance of Pt/C catalysts. The Pt nanoparticles on the external surfaces of carbon supports are readily accessible to reactants of oxygen and protons, which is beneficial to maximizing the catalyst/ionomer interface and lowering the mass transport resistance in the catalyst layer. To understand the distribution of PtCo intermetallic nanoparticles on the internal and external surfaces of the carbon supports, scanning transmission electron microscopy (STEM) was used to simultaneously acquire secondary electron (SE) and high-angle annular dark-field (HAADF) images, as shown in FIG. 2A-2D. The SE images reveal the PtCo intermetallic nanoparticles only on the external surfaces of the carbon supports, whereas PtCo intermetallic nanoparticles on both the external and internal surfaces are visible in the HADDF image. The percentage of PtCo intermetallic nanoparticles on the external surface for PtCo/KB—NH₂ (FIG. 2C and 2D) is much higher than that for PtCo/KB (FIG. 2A and 2B), which may be due to the fact that most of the PtCo intermetallic nanoparticles for PtCo/KB—NH₂ were deposited in mesopores open at the external surfaces of the carbon supports, whereas a large number of PtCo intermetallic nanoparticles for PtCo/KB reside within the internal micropores. The sufficient mesopores of KB—NH₂ enabled the formation of L1₀-PtCo intermetallic nanoparticles to be primarily deposited on the external surfaces. It was estimated that 93% and 41% of PtCo intermetallic nanoparticles were located on the external surfaces for PtCo/KB—NH₂ and PtCo/KB, respectively, which agreed well with the observations on Pt seed counterparts and commercial Pt/KB reported previously, further confirming the effective control of seed guidance over the precursor deposition and subsequent formation of L1₀-PtCo intermetallic nanoparticles.

Atomic resolution STEM was employed to investigate the detailed structure of PtCo/KB—NH₂ nanoparticles. A representative PtCo intermetallic nanoparticle is illustrated in FIG. 2E, showing Pt layers of about 2 to 3 atoms over an L1₀-PtCo core. The atomically ordered structure of the L1₀-PtCo core was evidenced by the alternating arrangement of high (Pt) and low (Co) Z-contrast along the direction. Two lattice fringes with d-spacing values of 0.370 and 0.269 nm were observed in the core, corresponding to the (001) and (110) planes of the L1₀-PtCo structure, respectively. The superlattice spots indexed to the (001) and (110) planes in the inset fast Fourier transform (FFT) pattern also confirmed the formation of the L1₀-PtCo structure. Furthermore, the L1₀-PtCo core was found to be bounded by (111) facets covered with Pt, which is known to be highly active for ORR catalysis. STEM-EDS elemental maps of a single particle confirmed that the alternating contrast in the core arises from ordered rows of Pt and Co in the particle core, consistent with the ordered L1₀-PtCo structure, along with the presence of a Pt-rich surface layer. According to a line-scan profile, the shell thickness was estimated to be 0.56 nm, which is about 2 to 3 atomic Pt layers. The atomic ratio of Pt/Co for PtCo/KB—NH₂ was determined to be 72/28, which is a reasonable value considering that the ultrafine L1₀-PtCo intermetallic nanoparticles were subjected to post acid treatment. SHEXRD patterns of PtCo/KB—NH₂ and PtCo/KB matched well with the L1₀-PtCo structure. The diffraction peaks corresponding to the (111), (200), (220) and (311) planes are shifted to larger Bragg angles compared to the standard lines for pure Pt, indicating that smaller Co atoms were incorporated into the Pt fcc lattice and caused lattice contraction. Four well-defined peaks indexed to (001), (110), (201), and (112) planes of the L1₀-PtCo structure are considered to be indicators of ordered structure formation. The relative value of the measured intensity ratio of I₁₁₀/I₁₁₁ to the theoretical one can be used to evaluate the degree of ordering for the L1₀ intermetallic structure. The degree of ordering was estimated to be 52% and 55% for PtCo/KB—NH₂ and PtCo/KB, respectively, which are reasonable values considering the presence of disordered Pt shells over the ultrafine L1₀-PtCo core.

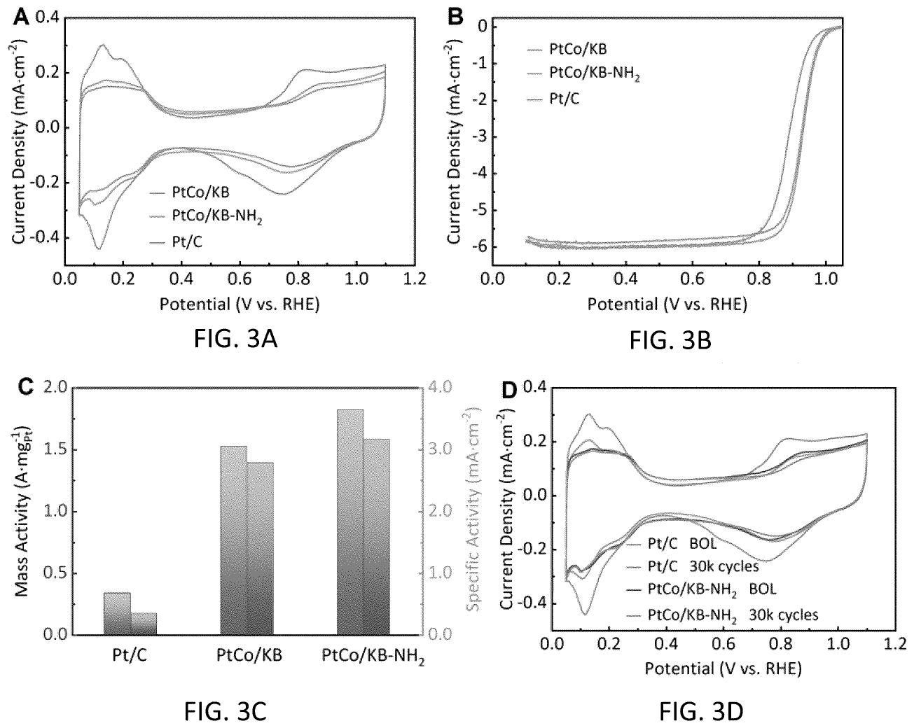

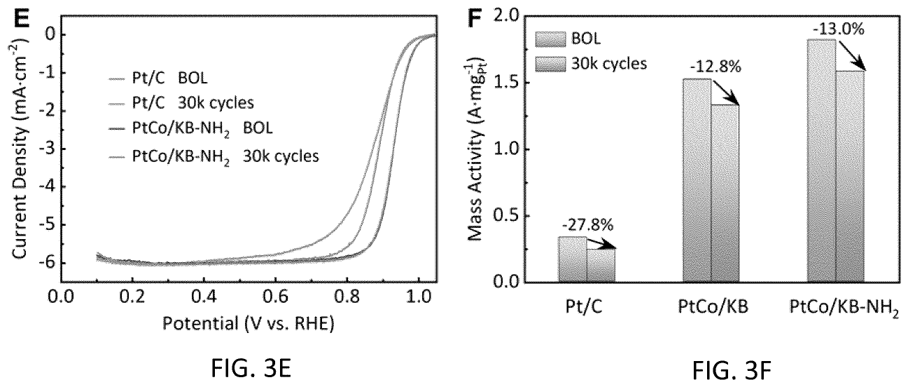

The ORR performances of PtCo/KB—NH₂ and PtCo/KB catalysts were investigated using RDE technique in 0.1 mol·L⁻¹ HClO₄ electrolytes. For comparison, one of the most active commercial Pt/C catalysts (TEC10E50E, Tanaka Kikinzoku Kogyo) was also tested under the same conditions. As shown by CV curves in FIG. 3A, both PtCo catalysts exhibited apparent shrinkages in the hydrogen absorption/desorption (HAD) regions when compared to commercial Pt/C, suggesting that part of the Pt atoms cannot be used for HAD due to the incorporation of Co atoms. Furthermore, the potentials associated with surface oxidation and oxide reduction were positively shifted for both PtCo catalysts relative to commercial Pt/C, suggesting the weakened oxophilicity of surface Pt. The electrochemical surface area (ECSA) determined from corresponding HAD regions was 54.3, 57.6, and 98.9 m²·g_{Pt}⁻¹ for PtCo/KB, PtCo/KB—NH₂, and commercial Pt/C, respectively. Because of the smaller particle size, PtCo/KB—NH₂ had a larger ECSA than PtCo/KB, which is about 2.1 times larger than the L1₀-PtCo/C with an average particle size of 8.9 nm reported previously. Using the CO stripping method, the ECSA of commercial Pt/C was determined to be 101.0 m²·g_{Pt}⁻¹, close to the value obtained from the HAD method (98.9 m²·g_{Pt}⁻¹). The enhanced ECSA could be obtained using the CO stripping method for PtCo/KB—NH₂ (73.5 m²·g_{Pt}⁻¹) and PtCo/KB (71.1 m²·g_{Pt}⁻¹), indicating the formation of a Pt-rich shell over the alloy structure. Because the CO stripping method may alter the structure and composition of Pt-based alloy particles, the ECSA values determined from the HAD method were used for further calculation below.

For ORR polarization curves (FIG. 3B), PtCo/KB—NH₂ delivered a half-wave potential (E12) of 0.93 V, which was higher than PtCo/KB (0.92 V) and commercial Pt/C (0.89 V), indicating enhanced ORR activity. Mass activity (MA) and specific activity (SA) were calculated by normalizing the kinetic current at 0.90 V over Pt loading and ECSA, respectively. As shown in FIG. 3C, PtCo/KB—NH₂ exhibited excellent MA (1.82 A·mg_{Pt}⁻¹) and SA (3.16 mA·cm 2), revealing 5.5- and 9.3-time enhancements over commercial Pt/C (MA: 0.33 A·mg_{Pt}⁻¹, SA: 0.34 mA·cm 2) and representing one of the most active Pt-based electrocatalysts. PtCo/KB had lower MA (1.53 A·mg_{Pt}⁻¹) and SA (2.78 mA·cm 2), but was still much higher than commercial Pt/C. Catalyst durability was further examined by performing 30,000 potential cycles between 0.60 and 0.95 V at room temperature. PtCo/KB—NH₂ (FIGS. 3D and 3E) and PtCo/KB showed excellent durability with minor changes in ORR polarization and CV curves. In contrast, the E12 of commercial Pt/C decreased by 17 mV and ECSA dropped by 27.5%. As shown in FIG. 3F, the MA of commercial Pt/C decreased by 27.8%, while that of PtCo/KB and PtCo/KB—NH₂ dropped by only 12.8% and 13.0%, respectively, after 30,000 cycles. The MA of PtCo/KB—NH₂ maintained a high level of 1.58 A·mg_{Pt}⁻¹ after 30,000 cycles, approaching 6.6 times that of commercial Pt/C (0.24 A·mg_{Pt}⁻¹).

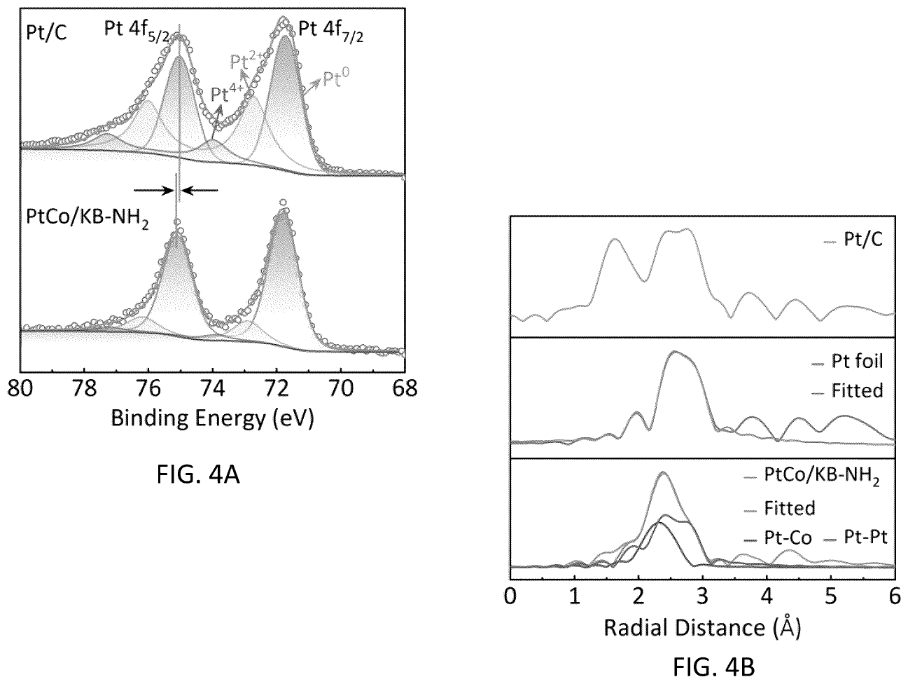

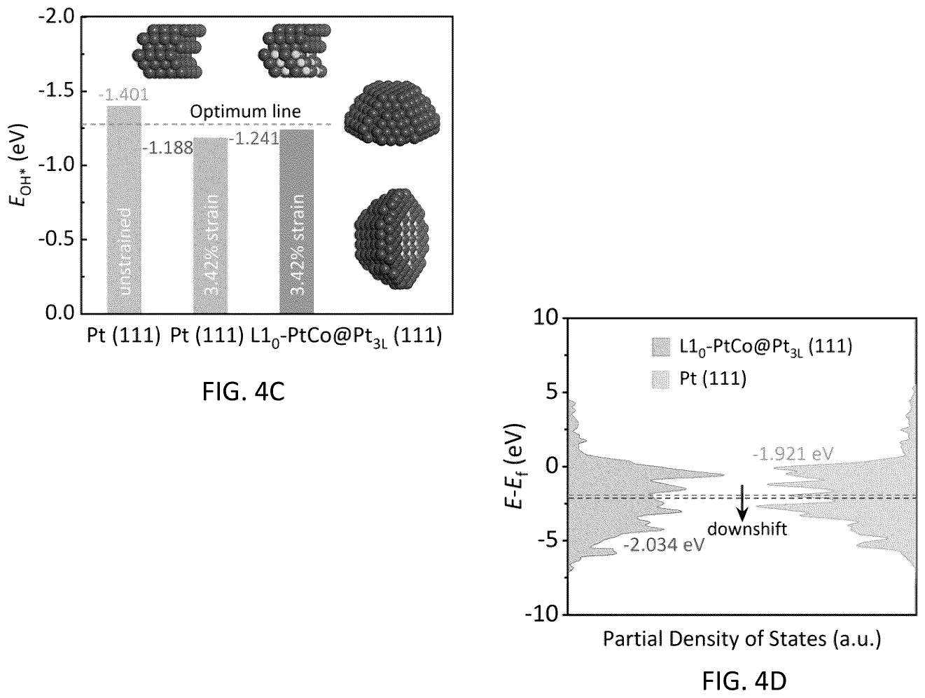

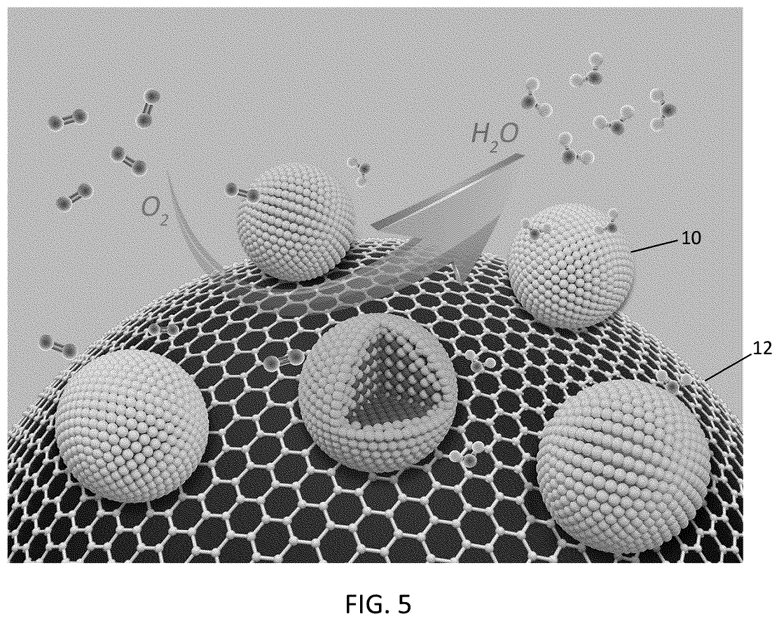

To understand the excellent activity and durability of PtCo/KB—NH₂, X-ray photoelectron spectroscopy (XPS) and X-ray adsorption spectroscopy (XAS) were employed to characterize these catalysts. As illustrated by XPS results (FIG. 4A), PtCo/KB—NH₂ exhibited a positive shift in the binding energy of Pt 4f spectrum relative to that of commercial Pt/C, indicating a strong electronic interaction between Pt and Co atoms. This electron effect may cause a downward shift in the d-band center of surface Pt, which is known to be favorable for enhancing ORR kinetics. Furthermore, the metallic Pt⁰ content of surface Pt in PtCo/KB—NH₂ (80.6%) was much higher than that of commercial Pt/C (50.6%), consistent with observations on other Pt-based intermetallic catalysts, indicating an enhanced resistance against Pt oxidation in PtCo/KB—NH₂.

The enhanced resistance against Pt oxidation agreed well with observations from the CV curves (FIG. 3A) and the Pt L3-edge EXAFS spectra (FIG. 4B), which would apparently improve the catalyst durability. In the Pt L3-edge EXAFS spectra, the distinct peak around 1.64 Å associated with the Pt—O coordination in commercial Pt/C was not observed in Pt foil and PtCo/KB—NH₂. Furthermore, the fitted length of the Pt—Pt bond in PtCo/KB—NH₂ (2.70 Å) was shown to be much shorter than that in Pt foil (2.76 Å), indicating that smaller Co atoms entered the Pt lattice and formed the PtCo alloy. The shortening of the Pt—Pt bond would inevitably induce a compressive strain over surface Pt, which is known to weaken the adsorption of oxygenated intermediates and therefore accelerate ORR kinetics.

To gain a deep insight into the ORR reactivity of PtCo/KB—NH₂, density functional theory (DFT) calculations were performed to simulate a 2.6 nm sized L1₀-PtCo@Pt_{3L} (3 atomic Pt layers over a L1₀-PtCo core) nanoparticle using a semispherical model (right insets in FIG. 4C). The results revealed a compressive strain of 3.42% in the Pt—Pt bond on the (111) facet with respect to the fcc Pt bulk. It is known that relatively strong adsorption to oxygenated intermediates (O*, OH*, etc.) limits the ORR kinetics of pure Pt. The binding energy of OH* (E_{OH*}) on a metal surface was recently identified as a key descriptor for ORR kinetics, and the optimum ORR activity was expected to be achieved at an E_{OH*} of roughly about 0.12 to about 0.14 eV weaker than that of unstrained Pt (111). To reduce the computational cost, the E_{OH*} was calculated using a slab model (top insets in FIG. 4C), and then the strain obtained using the semispherical model (right insets in FIG. 4C) was imposed to account for the nanoscale effects on the structure, which was found essential to calculate the ORR activity. As shown in FIG. 4C, the E_{OH*} on the L1₀-PtCo@Pt_{3L} (111) with a compressive strain of 3.42% was calculated to be −1.241 eV, which is 0.16 eV weaker than that on unstrained Pt (111) and much closer to the optimum E_{OH*}. This weakened E_{OH*} is associated with a 0.113 eV downshift of the d-band center on L1₀-PtCo@Pt_{3L} (111) relative to Pt (111) based on the calculated partial density of states (PDOS) (FIG. 4D), which led to the enhanced ORR kinetics.

To separate the influence of ligand effect and strain effect on E_{OH*}, the same 3.42% compressive strain was applied to the Pt (111) surface. The E_{OH*} varied dramatically from −1.401 eV on unstrained Pt (111) to −1.188 eV on 3.42% strained Pt (111), going from too strong to too weak compared to the theoretical optimum value, which indicated that the strain-induced variation reached as high as 0.213 eV. Additionally, the strain is positively correlated with E_{OH*} on Pt (111) and L1₀-PtCo@Pt_{3L} (111); that is, the increased strain resulted in higher E_{OH*}. Due to the presence of Co atoms deep in the core structure, the influence of the ligand effect on E_{OH*} was subtle but not negligible compared to the strain effect. The E_{OH*} on L1₀-PtCo@Pt_{3L} (111) was 0.053 eV lower than that on Pt (111) if the same 3.42% compressive strain is applied, indicating that the presence of the L1₀-PtCo core (ligand effect) brings the E_{OH*} closer to the theoretical optimum value. The synergy between strain and ligand effects tuned E_{OH*} to a just-right level for optimum ORR activity, which explained the excellent activity of PtCo/KB—NH₂ from a theoretical point of view.

Translating the excellent ORR activity into fuel cell performance remains a great challenge because of the insufficient Pt utilization and mass transport in the MEAs for traditional high-active Pt-based catalysts. Membrane electrode assembly (MEA) performance using PtCo/KB—NH₂ as the cathode catalyst was examined and compared with that using PtCo/KB and commercial Pt/C. THE MEA was fabricated by ultrasonically spraying cathode/anode catalyst inks onto a 15 μm membrane (Gore M820.15) using an ExactCoat spray coating system (Sono-Tek, NY). The as-prepared PtCo/KB—NH₂, PtCo/KB, or commercial 46.4 wt. % Pt/C (TEC10E50E, Tanaka Kikinzoku Kogyo) was dispersed into an n-propanol aqueous solution (10 wt. % n-PA/90 wt. % H₂O) with the ionomer solution (Aquivion D72-25BS, 720 EW) as cathode catalyst ink. The solid content was 2.0 mg·mL⁻¹, and weight ratios of ionomer/carbon (I/C) for PtCo/KB—NH₂ and PtCo/KB were controlled to be 0.50 and 0.60, respectively. Commercial 30 wt. % Pt/C (Jiping New Energy) was used as an anode catalyst with an I/C ratio of 0.4 5. All catalyst inks were homogenized using an ultrasonic bath for 30 minutes and a sonic dismembrator for 4 minutes. Catalyst coated membranes (CCMs) were sandwiched between two gas diffusion layers without hot pressing.

In H₂/air fuel cells using a cathode loading of 0.10 mg_{Pt}·cm⁻², the MEA of PtCo/KB—NH₂ showed the best performance over the entire range of polarization curves, particularly in the low voltage region dominated by mass transport resistance. The MEA of PtCo/KB—NH₂ delivered an excellent MA (at 0.90 V_{iR}-free) of 0.691 A·mg_{Pt}⁻¹, which far exceeded that of PtCo/KB (0.583 A·mg_{Pt}⁻¹) and the U.S. DOE target (0.440 A·mg_{Pt}⁻¹). In contrast, the MEA of commercial Pt/C exhibited a relatively low MA of 0.241 A·mg_{Pt}⁻¹. An extremely high current density of 480 mA·cm 2 at 0.80 V was achieved using the MEA of PtCo/KB—NH₂, which is 1.6 times the U.S. DOE target (300 mA·cm 2).

It is well known that MEA performance in the high voltage region is dominated by the intrinsic activity of the cathode catalyst. The uniform and ultrafine L1₀-PtCo@Pt_{3L} structure of PtCo catalysts enabled the superior activities in both RDE and MEA tests. More importantly, at the operating voltage of 0.67 V for practical fuel cell application, where the performance is also limited by mass transport, the MEA of PtCo/KB—NH₂ exhibited a record-high power density of 0.96 W·cm⁻². This rated power density closely approaches the U.S. DOE target of 1.0 W·cm⁻², which outperformed that of PtCo/KB (0.89 W·cm⁻²), commercial Pt/C (0.78 W·cm⁻²), and other reported Pt-based catalysts. Furthermore, in H₂/O₂ fuel cells, a maximum power density of 2.65 W·cm⁻² (at 0.45 V) was achieved using PtCo/KB—NH₂.

To interpret the impressive MEA performance of PtCo/KB—NH₂ catalyst, electrochemical impedance spectra were recorded at 0.60 V in H₂/air fuel cells and fitted using an equivalent circuit described previously.58 In Nyquist plots of these studied catalysts, the MEA of PtCo/KB—NH₂ had the smallest impedance arc, corresponding to the best MEA performance. The MEA performance was dominated by the cathode activation resistance (R_{cathode}) and mass transport resistance (Rₘₜ), because they are much larger than ohmic resistance (R_{Ω}) and anode activation resistance (R_{anode}). The R_{cathode} of PtCo/KB—NH₂ (123.7 mΩ·cm²) was lower than that of PtCo/KB (232.7 mΩ·cm²) and commercial Pt/C (333.0 mΩ·cm²), which agreed well with the intrinsic activities revealed in FIG. 3C. More importantly, the Rₘₜ of PtCo/KB—NH₂ (152.2 mΩ·cm²) was also much lower than that of PtCo/KB (231.0 mΩ·cm²) and commercial Pt/C (192.0 mΩ·cm²), confirming that the deposition of L1₀-PtCo intermetallic nanoparticles primarily on the external surface of carbon supports reduced the mass transport resistance. The specific pore volume of the catalyst layer fabricated using PtCo/KB was higher than that using PtCo/KB —NH₂, ruling out the possibility that the lower Rₘₜ is caused by a more porous structure of the corresponding catalyst layer.

The Pt utilizations in MEAs were calculated by obtaining the relative values of the ECSA determined in the MEA to the ECSA determined in the RDE (FIG. 3A). The PtCo/KB—NH₂ delivered an extremely high Pt utilization of 95.1% in the MEA because most of the PtCo intermetallic nanoparticles are deposited on the external surface and thus accessible to proton-conducting ionomers. However, PtCo/KB and commercial Pt/C had lower Pt utilizations of 83.2% and 80.8% in MEAs, respectively, which are close to the reported commercial Pt/KB,59 attributed to the fact that a large number of catalyst nanoparticles were embedded into the micropores and poorly accessible to ionomers. Therefore, PtCo/KB—NH₂ enabled an enhanced accessible active area in the MEA and lowered the mass transport resistance, resulting in extremely high power performance.

Accelerated durability tests (ADTs) were performed by cycling the MEAs between 0.60 and 0.95 V for 30,000 voltage cycles using the U.S. DOE testing protocol. The MEA of commercial Pt/C appeared to suffer a severe degradation after the ADT, showing a MA loss of 63.1% and a voltage drop of 170 mV (at 0.8 A·cm⁻²). Both MEAs of PtCo/KB—NH₂ and PtCo/KB demonstrated excellent durability with a voltage loss of 30 mV (at 0.8 A·cm⁻²) after the ADT, reaching the U.S. DOE target of 30 mV. The MA of PtCo/KB—NH₂ was maintained at a high level of 0.380 A·mg_{Pt}⁻¹ after the ADT, surpassing the U.S. DOE target of 0.264 A·mg_{Pt}⁻¹. The retained MEA performance of PtCo/KB—NH₂ after the ADT was comparable to the initial MEA performance of commercial Pt/C. The MEA performance of PtCo/KB—NH₂ reached nearly all U.S. DOE requirements for light-duty vehicles, indicating a great potential of PtCo/KB—NH₂ for fuel cell applications.

To investigate its potential application in heavy-duty vehicles, the long-term performance was further examined by cycling a MEA using a cathode loading of 0.20 mg_{Pt}·cm⁻² for 90,000 voltage cycles. The initial MEA performance was enhanced because of the higher Pt loading, showing a power density of 1.02 W·cm₋₂ (at 0.67 V). The MEA performance decayed significantly for the first 30,000 cycles and then slightly decayed over the subsequent cycles. The current density at 0.70 V dropped from 1.31 to 0.83 A·cm⁻² after 90,000 cycles, indicating a current decay of 36.6%. Given the low testing pressure of 150 kPa_{abs}, the retained current density of 0.83 A·cm⁻² was a promising result, albeit below the U.S. DOE target of 1.07 A·cm⁻² for heavy-duty vehicles testing at 250 kPa_{abs}.

To gain insights into the catalyst degradation mechanisms, the microstructure of PtCo/KB—NH₂ in the MEA after 30,000 voltage cycles was examined in detail. The PtCo intermetallic nanoparticles remained well-dispersed on the carbon support after the ADT, although the average particle size increased from 2.7±1.0 nm to 5.9±2.5 nm. In contrast, severe coarsening of Pt nanoparticles was observed for commercial Pt/C after the ADT, resulting in the average particle size remarkably increasing from 2.6±1.0 nm to 7.2±3.0 nm. The enhanced sintering resistance has been reported in the literature for Pt—Co, Pt—Ni, and Pt—Fe alloys when compared with pure Pt catalysts, which may be offered by the alloying metal (i.e., the anchor effects of alloying metals on the carbon supports). Typical lattice fringes indexed to the (001) plane of the L1₀-PtCo structure and alternating Z-contrasts could be clearly identified, indicating that the intermetallic structure was well-preserved after the ADT, which definitely contributed to the excellent durability. The L1₀-PtCo intermetallic nanoparticles exhibited a more defined core-shell structure after the ADT, showing a shell thickness of 0.90 nm, which is about 4 atomic Pt layers. Although a large amount of Co was observed to remain in the core structure after the ADT, the Co content in L1₀-PtCo intermetallic nanoparticles decreased from 28 at. % (initial value) to 20 at. % (after the ADT) due to inevitable Co dissolution. The structure change was further evidenced by a SHEXRD pattern after the ADT, showing both diffraction peaks corresponding to the L1₀-PtCo structure and emerging splitting peaks belonging to pure Pt. The R₁₀₆ remained almost unchanged at 31.1 mΩ·cm² after the ADT, indicating that the dissolved Co did not lead to a significant increase in the proton conduction resistance of the ionomer and membrane, which is consistent with the previous observation of PtCo/C catalyst.

The effect of surface Co dissolution on the kinetic activity of L1₀-PtCo intermetallic nanoparticles was further studied by calculating the E_{OH}* on L1₀-PtCo@Pt_{4L}. Compared to L1₀-PtCo@Pt_{3L} (−1.241 eV), the F_{OH}* varied slightly on L1₀-PtCo@Pt_{4L} (−1.237 eV) because the compressive strain remained almost unchanged at 3.42%, indicating that surface Co dissolution may not result in a significant reduction in ORR activity. The surface contraction induced by the Pt—Co lattice mismatch faded away on the nanoparticles with thicker shells, consistent with that observed on Pt@Pd nanoparticles. Therefore, the MEA performance degradation could be mainly attributed to the reduction in active area caused by the increase in particle size. Future work is underway to prepare Pt-based intermetallic nanoparticles on other types of functionalized carbon supports to improve the catalyst durability.

The investigations and procedures described above evidence an uncomplicated and effective approach was developed to directly synthesize ultrafine (sub-3 nm) noble metal-containing nanoparticles on external surfaces of carbon supports, as well as within mesopores at the external surfaces of the supports. The representative PtCo/KB—NH₂ nanoparticles exhibited atomic Pt layers of about 2 to 3 atomic thicknesses over the L1₀-PtCo core, showing excellent ORR activity (MA of 1.82 A·mg_{Pt}⁻¹) and durability (13.0% MA loss after 30,000 cycles) in the RDE tests. DFT calculations revealed that a synergy of ligand effect and strain effect weakened the adsorption of oxygenated intermediates on PtCo/KB—NH₂ nanoparticles to a near-optimal value. The formation of a L1₀-PtCo structure and enhanced resistance against surface Pt oxidation in PtCo/KB—NH₂ led to superior durability. More importantly, the excellent activity could be well translated into fuel cell performance because of the enhanced accessibility of PtCo/KB—NH₂ nanoparticles, resulting in high Pt utilization and low mass transport resistance in the MEA. Using a low cathode loading of 0.10 mg_{Pt}·cm⁻², the MEA of PtCo/KB—NH₂ delivered a superior MA of 0.691 A·mg_{Pt}⁻¹, a very high power density of 0.96 W·cm⁻² at 0.67 V, and only a 30 mV drop at 0.80 A·cm 2 after 30,000 voltage cycles. Furthermore, the current density could be maintained at a high level of 0.83 A·cm⁻² at 0.70 V (under a reasonably low pressure testing condition of 150 kPa_{abs}) after 90,000 cycles, suggesting a great potential application of PtCo/KB—NH₂ in heavy-duty vehicles. As such, the investigations not only evidenced a successful approach to preparing uniform and ultrafine Pt-based intermetallic electrocatalysts, but also provided an effective direction for overcoming the mass transport problem to achieve high-power fuel cells as well as other energy conversion and storage devices.

As previously noted above, though the foregoing detailed description describes certain aspects of one or more particular embodiments of the invention and investigations associated with the invention, alternatives could be adopted by one skilled in the art. For example, process parameters such as concentrations, temperatures, and durations could be modified, and appropriate materials could be substituted for those noted, as a nonlimiting example, other noble metals in addition to or instead of platinum, such as ruthenium, rhodium, palladium, osmium, and iridium, alloys thereof, and ordered intermetallics thereof. As such, and again as was previously noted, it should be understood that the invention is not necessarily limited to any particular investigation or embodiment described herein or illustrated in the drawings.

1. A method of forming a catalyst on a catalyst support, the method comprising:
guiding ions of a precursor of the catalyst to land uniformly on an NH₂-modified surface of the catalyst support; and
depositing fine monodisperse nanoparticles on the NH₂-modified surface with the ions of the precursor thereon.

2. The method of claim 1, further comprising:
heat treating the fine monodisperse nanoparticles to form intermetallic nanoparticles of the catalyst.

3. The method of claim 2, wherein the intermetallic nanoparticles have an intermetallic core and one or more atomic noble metal layers over the intermetallic core.

4. The method of claim 2, wherein the intermetallic nanoparticles comprise noble metal atoms.

5. The method of claim 2, wherein the intermetallic nanoparticles comprise transition metal atoms.

6. The method of claim 2, wherein the intermetallic nanoparticles contain platinum and at least one of cobalt, nickel, iron, and zinc.

7. The method of claim 1, wherein in the step of guiding, the ions of the precursor and protonated ammonium ions (NH₃⁺) on the NH₂-modified surface have opposite charges resulting in a strong electrostatic attraction therebetween.

8. The method of claim 1, wherein the fine monodisperse nanoparticles have an average size of less than 2 nm.

9. The method of claim 8, wherein the fine monodisperse nanoparticles have an average size of 1.5±0.3 nm.

10. The method of claim 1, wherein the fine monodisperse nanoparticles are present on the NH₂-modified surface of the catalyst support and within mesopores in the NH₂-modified surface of the catalyst support.

11. The method of claim 1, wherein the ions of the precursor are Pt complex ions.

12. The method of claim 1, wherein the catalyst support is a carbon support.

13. The method of claim 1, further comprising:
treating the catalyst support to form the NH₂-modified surface thereon.

14. The method of claim 13, wherein treating the catalyst support comprises treating the catalyst support with a source of p-benzene amino (—NH₂) groups.

15. The method of claim 13, wherein the catalyst support contains micropores prior to being treated, and wherein treating the catalyst support decreases the specific volume of the micropores.

16. The combination catalyst and catalyst support formed by the method of claim 1.

17. A catalyst layer comprising the combination catalyst and catalyst support formed by the method of claim 1.

18. An electrode comprising the catalyst layer of claim 17.

19. A membrane electrode assembly comprising the electrode of claim 18.

20. A polymer electrolyte membrane fuel cell comprising the membrane electrode assembly of claim 19.

21. A vehicle comprising the polymer electrolyte membrane fuel cell of claim 20 installed in the vehicle.
